(19) United States
(12) Patent Application Publication
(10) Pub. No.: US 2020/0097142 A1
(43) Pub. Date: Mar. 26, 2020

(54) SYSTEM AND METHOD FOR LINKING APPLICATIONS DURING CALL USING SMARTPHONE

(71) Applicant: Hanseok KIM, Seoul (KR)

(72) Inventor: Hanseok KIM, Seoul (KR)

(73) Assignees: Hanseok KIM, Seoul (KR); NARGO Inc., Seoul (KR); Jinha PARK, Daejeon (KR)

(21) Appl. No.: 16/495,654

(22) PCT Filed: Mar. 20, 2018
(86) PCT No.: PCT/KR2018/003210

§ 371 Date: Sep. 19, 2019

(30) Foreign Application Priority Data
Mar. 22, 2017 (KR) 10-2017-0036240

(51) Int. Cl. G06F 3/0482; G06F 3/0484; H04L 29/08; H04M 3/42; H04W 4/90; H04W 4/23; G06Q 30/02; G06Q 10/10

(52) U.S. Cl. CPC G06F 3/0482; G06F 3/04847; H04L 67/26; H04M 3/42042; H04W 4/90; G06Q 10/107; H04W 4/23; H04L 67/141; G06Q 30/0277; G06Q 10/109; H04L 67/02

(57) ABSTRACT

A system for linking applications during a call using a smartphone includes a telephone call module for connecting a telephone call with a caller terminal based on a call connection of the caller terminal, and outputting a call waiting screen for waiting for an answer from a user corresponding to the call connection, a busy screen displaying a call status with the caller terminal, and a call termination screen displaying a call termination status with the caller terminal; and a busy application linking module for providing a display window showing linked application icons including linked application execution icons on the call waiting or busy screen, and when one of the linked application execution icons is inputted, invoking and executing a corresponding linked application on the call waiting or screen, and when use of the linked application is terminated, automatically returning the screen to the call waiting or busy mode.

### BACKGROUND

### 1. Technical Field

The present invention relates to a system and method for a link to an application during a call using a smartphone and, more particularly, to a system and method for linking applications during a call using a smartphone, in which the applications can be linked and executed by one click on each of a call waiting screen, a busy screen, and a call end screen.

### 2. Related Art

As the functions of a mobile terminal are recently expanded, the mobile terminal makes a great step forward from a device for only a phone call simply, and various applications are installed and operated in the mobile terminal based on an operating system, such as Android or iOS. Such a communication terminal is called a “smartphone.”

The operating system of the smartphone supports the development and use of various applications. In addition to applications basically installed when the smartphone is initially released, a user may access a mobile market or an Internet webpage and may install and use a desired application.

In order to execute an application in the smartphone, the icon of the corresponding application needs to be input by a touch. In general, execution icons are disposed on a home screen or wallpaper linked to the home screen, and an application is executed by one-clicking an icon.

However, if a user wants to execute a desired application in a call waiting screen or a busy screen, the user has to exit from a call connection screen and to execute the application.

In particular, if a user undergoes voice phishing that impersonates his or her child, receives a call from an abductor or receives a call from a person in an emergency situation, the user needs to immediately check a corresponding fact with his or her child or to report the emergency situation during a call. In this case, the user has to use a report app in a call waiting state or during a call with the caller who is suspected as voice phishing. However, there is a problem in that a process of finding and executing a report app on a screen after selecting a home key to exit from the call waiting screen or the busy screen and then executing a home screen or an app box is very inconvenient for the user. Furthermore, the user frequently gives up such a series of procedures because the user is worried that the procedures are discovered by a criminal.

For another example, a process of executing a typically known application on a call waiting screen or a busy screen is very inconvenient. For example, when a caller telephone number is displayed on a call waiting screen through a caller identification display (CID) service, in some cases, a user may check photos of the caller, text messages exchanged with the caller, or memos stored in relation to the caller by executing a gallery app, a messenger app or a memo app in order to search for more detailed information on the caller. At this time, the user has to move to a home screen by selecting a home key ion a call waiting screen or has to move to a screen on which apps are listed by selecting an app button. In most cases, a user can execute a desired app through many steps of key inputs. Furthermore, after check, the user has to return to the call waiting screen and to receive a call. To return a screen to the call waiting screen is very inconvenient, and the reception of a corresponding call is frequently cut off due to an erroneous input.

For still another example, if automatic response service (ARS) is used, personal information or a bank account number may be input through a keypad during a call. In general, a button for activating a virtual keypad is provided on a busy screen. A user inputs information required by ARS by activating the keypad. However, if the user forgets personal information or a bank account number, the user has to search an address book or a memo for the personal information or the bank account number. Even in this case, in the state in which a virtual keypad has been activated, the user has to move to a home screen by selecting a home key, to find and execute a desired application, to return to the original screen after the search is finished, and to execute the virtual keypad again. Accordingly, there is a problem in that a very complicated process must be performed.

For yet another example, a user may have to check or newly input a meeting schedule during a call related to business. Even in this case, the user has to exit from a busy screen by selecting a home key and then to execute a schedule management app (e.g., an app for checking and inputting a schedule along with a calendar). After the check or input of schedule management is finished, the user has to return to the busy screen by executing a telephone call app again. Such a problem makes a user hesitate to use a schedule management application during a call. Accordingly, after a call is terminated, a user frequently checks schedule management or newly inputs a schedule by executing a schedule management app. A problem may occur in that a user erroneously inputs a meeting date or does not input important contents related to a meeting schedule because the user does not correctly remember dialogue contents during a call.

Korean Patent No. 10-0660655 discloses a method and apparatus for managing a schedule after a call is ended in a mobile terminal, wherein a user can immediately manage a schedule before the user forgets the contents of a call. The prior art document describes a series of processes in which when a schedule management request is received from a user after a call is ended, a schedule management screen is directly connected to a call end screen and a date and schedule contents are received and registered.

However, there is still a possibility that the user may erroneously input a schedule or omit important contents because the schedule management application is connected after a call is terminated and thus the user does not remember dialogue contents. Furthermore, there is a problem in that the user cannot cross-check schedules and important memos exchanged with a caller during a call

### SUMMARY

An object of the prevent invention is to provide an application link system and method during a call, which enable a user to effectively use applications even during a call and can enhance user convenience by providing a link app execution menu capable of executing applications by one click on a call waiting screen, busy screen, or call end screen and enabling a user to execute link apps by one input and return to an original screen related to a call.

Furthermore, another object of the prevent invention is to enable a user to execute an emergency notification application by one click on a call waiting screen or a busy screen and to confirm a voice phishing fact through a pre-designated mobile phone of a child, immediately report a crime scene to the police or report an urgent situation to a fire station for immediate measures, while the user stays on the line with a caller, by notifying pre-designated contact information of the voice phishing fact or transmitting an emergency rescue signal to the police, a fire station or an cyber safety administration on an emergency notification page.

Furthermore, a still another object of the prevent invention is to provide a user with various types of information and discount benefits by providing advertising content and link service to an idle space in an environment in which a link app is not executed.

Furthermore, a yet another object of the prevent invention is to enable a user to easily read detailed information on a caller and text messages exchanged with the caller by searching for a business card matched with caller information and providing the searched business card to a call waiting screen or a busy screen.

Furthermore, a still yet another object of the prevent invention is to enable a user to immediately check and write a schedule, related to a call, in relation to the year, month and day of a calendar by displaying a schedule management application on a screen of a call connection state.

Furthermore, a further object of the prevent invention is to enable a user to cross-check a schedule or memo in real time by transmitting and sharing a specific schedule or memo during a call to and with a caller or a third party.

Furthermore, another further object of the prevent invention is to enable easy and fast voice search by cutting off a received sound in a toggle way by one click on a call connection screen using a received sound erasure toggle icon and to convert a voice signal into text for an input, when contact information or Internet search is performed using a voice recognition engine during a call.

Problems to be solved by the present invention are not limited to the above-described problems, and other problems not described above will be evidently understood by those skilled in the art from the following description.

An application link system during a call using a smartphone according to an embodiment of the present invention includes a telephone call module configured to connect a telephone call with a caller terminal based on call access of the caller terminal and display a call waiting screen for waiting for a response from a user corresponding to the call access, a busy screen for displaying a busy state with the caller terminal, and a call end screen for displaying a termination state of a call with the caller terminal; and a busy app link module configured to provide a link application icon display window including a plurality of link app execution icons on the call waiting screen or the busy screen, invoke a corresponding link app when the link app execution icon is selected and execute the corresponding link app on each of the call waiting screen and the busy screen, and automatically return a screen to the call waiting screen or the busy screen when the use of the link app is terminated.

In the application link system during a call using a smartphone according to another embodiment of the present invention, an emergency notification application execution icon is displayed in the link application icon display window. The application link system further includes an emergency notification module configured to display an emergency notification page on which a user interface for notifying voice phishing or an emergency rescue is provided on the call waiting screen or the busy screen if the emergency notification application execution icon is selected by a user and to notify a pre-designated subject of a voice phishing state or transmit an emergency rescue signal to the pre-designated subject in accordance with the user's input.

In the application link system during a call using a smartphone according to another embodiment of the present invention, the emergency notification page includes a voice phishing notification selection item which is a user input item for notifying the designated subject of the voice phishing state, and an emergency rescue notification selection item which is a user input item for transmitting the emergency rescue signal.

In the application link system during a call using a smartphone according to another embodiment of the present invention, when the voice phishing notification selection item is selected by a user, the emergency notification module activates a voice phishing notification page on which the user designates a voice phishing notification subject and transmits a text message for notifying the voice phishing to a subject selected by the user in the voice phishing notification page or attempts a call connection with a mobile phone of the corresponding subject.

In the application link system during a call using a smartphone according to another embodiment of the present invention, when the emergency rescue notification selection item is selected by a user, the emergency notification module activates an emergency rescue notification page on which the user selects an emergency rescue report subject and transmits an emergency rescue signal to a report place selected by the user in the emergency rescue notification page or attempts a call connection with a telephone number of the report place.

The application link system during a call using a smartphone according to another embodiment of the present invention further includes a silence switching module configured to display a silence switching selection unit for switching a ringtone or vibration indicative of an incoming call on the call waiting screen into silence on a screen and to switch an incoming ringtone or vibration into silence when the silence switching selection unit is selected by a user.

In the application link system during a call using a smartphone according to another embodiment of the present invention, the silence switching selection unit is displayed on a screen in a slide input form on top of the call waiting screen. When the silence switching selection unit is slid and selected, the silence switching selection unit disappears and the link application icon display window is displayed at a corresponding location on the screen.

The application link system during a call using a smartphone according to another embodiment of the present invention further includes an advertising link module configured to provide advertising content and an advertising content link item on each of the call waiting screen, the busy screen, and the call end screen in a main menu state in which the link app has not been executed and to provide a link service to an advertising link mobile webpage associated with the advertising content when the advertising content link item is selected.

In the application link system during a call using a smartphone according to another embodiment of the present invention, the advertising link module displays push type advertising content on the call waiting screen and the busy screen so that the push type advertising content automatically slides and moves at given time intervals, and displays the advertising content, sliding and moving on the call waiting screen and the busy screen, on the call end screen so that the advertising content is manually slid and moved. The telephone call module provides a call end screen exit icon on the call end screen after a call end is selected by a user and terminates the call end screen if the call end screen exit icon is selected by a user.

In the application link system during a call using a smartphone according to another embodiment of the present invention, a main menu move icon is displayed in the link application icon display window. The advertising link module changes a state in which another link app is executed into a state in which the advertising content is displayed, when the main menu move icon is selected by a user.

In the application link system during a call using a smartphone according to another embodiment of the present invention, a business card search icon is displayed in the link application icon display window. The application link system further includes a caller matching business card search module configured to extract a business card previously stored in a memory in accordance with a caller telephone number provided by a caller identification display service, when the business card search icon is selected and to display the business card on a screen.

In the application link system during a call using a smartphone according to another embodiment of the present invention, the caller matching business card search module is adjacent to a business card display unit in which the business card is displayed and displays text messages, exchanged with the caller telephone number, on a screen.

In the application link system during a call using a smartphone according to another embodiment of the present invention, a contact information application execution icon is displayed in the link application icon display window. The busy app link module invokes and executes a contact information application installed on the smartphone when the contact information application execution icon is selected.

In the application link system during a call using a smartphone according to another embodiment of the present invention, a schedule management application execution icon is displayed in the link application icon display window. The application link system further includes a schedule management module configured to display, on a screen, a calendar display unit in which a calendar is displayed, a date display unit in which a date and a schedule title of a corresponding date are displayed, and a schedule addition selection button for adding and writing a new schedule when the schedule management application execution icon is selected by a user.

In the application link system during a call using a smartphone according to another embodiment of the present invention, if any one of the date display units is selected by a user, the schedule management module provides a schedule display window in which schedules of a corresponding date are displayed in time series, provides text, indicative of an individual schedule, as an individual schedule selection item capable of a touch input, on the schedule display window, and displays, on a screen, a detailed schedule display window in which a corresponding schedule is displayed in detail when the individual schedule selection item is selected by a user.

In the application link system during a call using a smartphone according to another embodiment of the present invention, the schedule management module provides a schedule sharing item on one side of the detailed schedule display window and provides a schedule sharing means selection window in which a sharing means of a corresponding schedule is selected when the schedule sharing item is selected by a user. At least two schedule sharing means selection items of e-mail, a text message, a web hard, and an SNS are displayed on the schedule sharing means selection window. When any one of the schedule sharing means selection items is selected, schedule information written in the detailed schedule display window is transmitted and shared through a selected sharing means.

In the application link system during a call using a smartphone according to another embodiment of the present invention, a permanent memo application execution icon is displayed on the link application icon display window. The application link system further includes a permanent memo module configured to fetch and execute a memo application when the permanent memo application execution icon is selected by a user.

In the application link system during a call using a smartphone according to another embodiment of the present invention, the permanent memo module invokes and executes the memo application when it is detected that a stylus pen inserted into one side of the smartphone is drawn, if any one of the call waiting screen, the busy screen, and the call end screen is displayed by the telephone call module.

In the application link system during a call using a smartphone according to another embodiment of the present invention, a voice search application execution icon is displayed in the link application icon display window. The busy app link module invokes and executes a voice search engine installed on the smartphone when the voice search application execution icon is selected by a user.

In the application link system during a call using a smartphone according to another embodiment of the present invention, an Internet search application execution icon is displayed in the link application icon display window. The busy app link module invokes and executes an Internet search application installed on the smartphone when the Internet search application execution icon is selected by a user.

In the application link system during a call using a smartphone according to another embodiment of the present invention, a point management application execution icon is displayed in the link application icon display window. The application link system further includes a point management module configured to display accumulated points and used points of a user on a screen when the point management application execution icon is selected by the user.

In the application link system during a call using a smartphone according to another embodiment of the present invention, a received sound erasure toggle icon is displayed in the link application icon display window. The busy app link module changes an erasure or return of a received sound when the received sound erasure toggle icon is selected by a user.

An application link method during a call using a smartphone according to an embodiment of the present invention includes (a) providing a call waiting screen for waiting for a response from a user in accordance with call access of a caller terminal; (b) providing a busy screen for displaying a call connection state with the caller terminal when a call connection is selected by a user on the call waiting screen; and (c) providing a call end screen for displaying a termination state of a call with the caller terminal when a call end is selected by a user on the busy screen, wherein a link application icon display window including a plurality of link app execution icons is provided on each of the call waiting screen or the busy screen, when the link app execution icon is selected, a corresponding link app is invoked and executed on each of the call waiting screen and the busy screen, and when the execution of the link app is terminated, a screen automatically returns to the call waiting screen or the busy screen.

In the application link method during a call using a smartphone according to another embodiment of the present invention, advertising content and an advertising content link item are provided on each of the call waiting screen, the busy screen, and the call end screen. When the advertising content link item is selected, a link service to an advertising link mobile webpage associated with the advertising content is provided.

### BRIEF DESCRIPTION OF THE DRAWINGS

FIG. 1 is a block diagram illustrating an application link system during a call using a smartphone according to the present invention.

FIG. 2 is a flowchart illustrating an application link method in a call waiting screen state in the present invention.

FIG. 3 is a flowchart illustrating an application link method in a busy screen state in the present invention.

FIG. 4 is a flowchart illustrating an application link method in a call end screen state in the present invention.

FIG. 5 is a diagram illustrating a call waiting screen when a call is received.

FIG. 6 is a diagram illustrating the state in which an emergency notification application has been executed in the present invention.

FIG. 7 is a diagram illustrating the state in which a screen in FIG. 6 has switched to a voice phishing notification screen.

FIG. 8 is a diagram illustrating an example in which information of a voice phishing notification subject is edited.

FIG. 9 is a diagram illustrating the state in which the screen in FIG. 6 has switched to an emergency rescue notification screen.

FIG. 10 is a diagram illustrating the state in which a page has moved to an advertising link mobile webpage.

FIG. 11 is a diagram illustrating the state in which a business card search application has been executed.

FIG. 12 is a diagram illustrating the main menu state of a busy screen.

FIG. 13 is a diagram illustrating the state in which a contact information application has been executed during a call.

FIG. 14 is a diagram illustrating the state in which a schedule management application has been executed during a call.

FIG. 15 is a diagram illustrating the state in which the schedule of a specific date has been displayed in the state of FIG. 14.

FIG. 16 is a diagram illustrating the state in which the detailed contents of a specific schedule have been displayed in the state of FIG. 15.

FIG. 17 is a diagram illustrating the state in which a sharing type of a specific schedule has been selected in the state of FIG. 16.

FIG. 18 is a diagram illustrating the state in which a permanent memo application has been executed during a call.

FIG. 19 is a diagram illustrating the state in which detailed memo contents have been displayed in the state of FIG. 18.

FIG. 20 is a diagram illustrating the state in which a voice search application has been executed during a call.

FIG. 21 is a diagram illustrating the state in which an Internet search application has been executed during a call.

FIG. 22 is a diagram illustrating the state in which a point management application has been executed during a call.

FIG. 23 is a diagram illustrating the state in which a point saving history has been displayed in the state of FIG. 22.

FIG. 24 is a diagram illustrating the state in which a point use history has been displayed in the state of FIG. 23.

FIG. 25 is a diagram illustrating the state in which a call end screen has been executed.

FIG. 26 is a diagram illustrating the state which a call end screen exit has been selected in the state of FIG. 25.

### DETAILED DESCRIPTION

Hereinafter, detailed embodiments according to the present invention will be described with reference to the accompanying drawings. It is however to be understood that the present invention is not intended to be limited to the specific embodiments and includes all changes, equivalents and substitutions which fall within the spirit and technological scope of the present invention.

The same reference numeral is assigned to a portion having a similar element and operation throughout the specification. Furthermore, the accompanying drawings of the present invention are for convenience of description, and shapes and relative criteria thereof may be exaggerated or omitted.

In specifically describing the embodiments, a redundant description or a description of a technique evident in a corresponding field has been omitted. Furthermore, in the following description, when it is described that one element “includes” the other element, the term “include” will be understood to imply the inclusion of not only stated elements but also any other elements, unless explicitly described to the contrary.

Furthermore, a term, such as “˜unit”, “˜er (or ˜or)”, or “˜module” described in the specification, means a unit for processing at least one function or operation, and this may be implemented by hardware or software or a combination of them. Furthermore, when it is described that one part is electrically connected to the other part, it should be understood that the one part may be directly connected to the other part or a third part may be interposed between the two parts.

Terms, such as the first and the second, may be used to describe various elements, but the elements are not restricted by the terms. The terms are used to only distinguish one element from the other element. For example, a first element may be named a second element without departing from the range of right of the disclosure. Likewise, a second element may be named a first element.

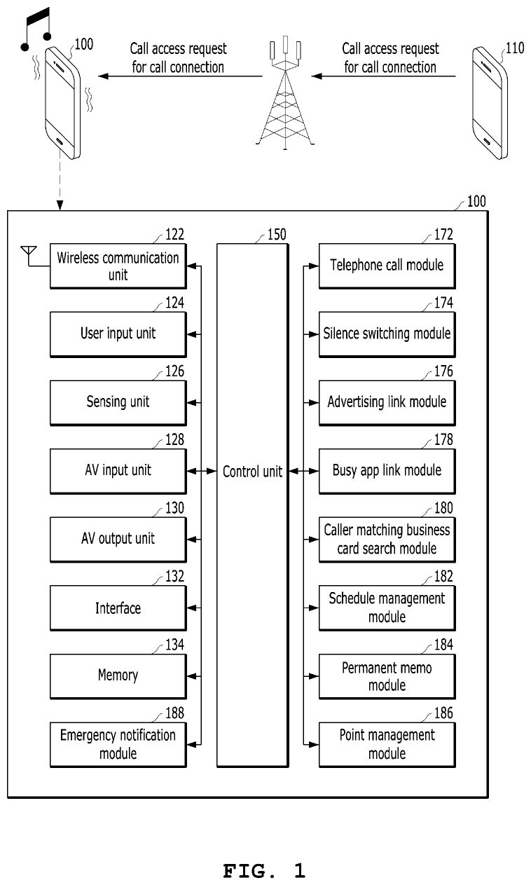

FIG. 1 is a block diagram illustrating an application link system during a call using a smartphone according to the present invention.

Referring to FIG. 1, as commonly known, when a call access request for a call connection is generated from a caller terminal 110, the call access request is received by a smartphone 100 of a user over a wireless communication network. The wireless communication network may be, for example, a mobile communication network, such as code division multiple access (CDMA) or long term evolution (LTE).

The application link system during a call using a smartphone according to the present invention has a configuration of a block diagram illustrated below the smartphone 100 in FIG. 1.

As commonly known, the smartphone 100 includes a wireless communication unit 122, a user input unit 124, a sensing unit 126, an AV input unit 128, an AV output unit 130, an interface 132, a memory 134, and a control unit 150.

The wireless communication unit 122 may include one or more modules enabling wireless communication with other communication terminals over a wireless communication network. For example, the wireless communication unit 122 may include modules, such as a mobile communication module, a wireless Internet module, a short-distance communication module, a GPS module, and a broadcast reception module.

The mobile communication module is connected to a base station, a relay terminal or a server and transmits and receives radio signals over a mobile communication network. The radio signal may include various types of data, such as a voice call signal, a video call signal, a text message, and a multimedia message.

The wireless Internet module is a module for wireless Internet access, and may be embedded in the smartphone 100 or connected to the smartphone 100 as an external device. For example, a wireless LAN (WLAN), Wi-Fi, a wireless broadband (WiBro), world interoperability for microwave access (Wimax), or high speed downlink packet access (HSDPA) may be used in the wireless Internet module.

The short-distance communication module is a module for enabling wireless communication in a short distance. A Bluetooth, radio frequency identification (RFID), infrared data association (IrDA), ultra wideband (UWB), or Zigbee module may be used as the short-distance communication module.

The GPS module is a module for obtaining information on the current location of the smartphone 100 from satellites, and is a module for calculating location and time information using three satellites.

The broadcast reception module is a module for receiving various broadcast signals. A digital multimedia broadcasting terrestrial (DMBT) module, a digital multimedia broadcasting satellite (DMBS) module, a media forward link only (MediaFLO) module, a digital video broadcasting handheld (DVBH) module, or an integrated services digital broadcasting terrestrial (ISDBT) module may be used as the broadcast reception module.

The user input unit 124 is a means for receiving control over an operation of the smartphone 100. A key pad, a dome switch, a mobile mouse, a jog wheel, a jog switch, a touch key or a touch panel may be used as the user input unit 124. In particular, in the present invention, a touch panel using a touch user interface (TUI) is used. A user may input a user command using various touch gestures.

The sensing unit 126 may be configured with various sensors for detecting the open/closed state, azimuth, or acceleration/deceleration of the smartphone 100 and whether a user input means has approached.

The AV input unit 128 is a means for receiving an audio signal and a video signal, and may include a camera and a microphone, for example. The camera processes the image frame of a still image or moving image detected by an image sensor in a video call mode or a photographing mode. The microphone processes a voice signal, received through a microphone in a call mode, a recording mode or a voice recognition mode, into electrical data.

The AV output unit 130 is a device for generating outputs related to visual, auditory and tactile senses, and may include a display means, a speaker, an alarm module or a haptic module.

The display means displays information, processed by the smartphone, on a screen. The display means displays a user interface (UI) or graphic user interface (GUI) related to the execution of a call or application. The display means may be configured as a liquid crystal display (LCD), a thin film transistor liquid crystal display, organic light emitting diodes, active matrix organic light emitting diodes

(AMOLED), or a flexible display, and may be configured as a touch screen on which a touch panel is integrated with a display device.

The interface 132 is a means for serving as a passage to an external device connected to the smartphone 100. The interface 132 transmits and receives data to and from an external device, receives power, and supplies the power to each of elements within the smartphone 100. For example, a wired ear jack, a wireless headset port, a charger connection port, a wired/wireless data port, a memory card port, an audio I/O port, and a video I/O port may be included in the interface 132.

The memory 134 is a means for storing data generated by or downloaded from the smartphone 100 or data received from the outside, and may include at least one type of storage media, such as a flash memory type, a hard disk type, a multimedia card micro type, a card type memory (e.g., SD or XD memory), a random access memory (RAM), a static random access memory (SRAM), a read only memory (ROM), an electrically erasable and programmable read only memory (EEPROM), a programmable read only memory (PROM), a magnetic memory, a magnetic disk, and an optical disk.

The control unit 150 controls an overall operation of the smartphone 100. For example, the control unit 150 performs control and data processing related to a voice call, data communication, a video call, or the execution of an application. Furthermore, the control unit 150 may control an operation and processing of an operating system installed on the smartphone 100, an application basically installed on the smartphone 100, an application downloaded and stored by a user, and an application and software module related to the present invention, which is to be described hereinafter.

In this case, the application link system during a call using a smartphone according to the present invention further includes a telephone call module 172, a silence switching module 174, an advertising link module 176, a busy app link module 178, a caller matching business card search module 180, a schedule management module 182, a permanent memo module 184, a point management module 186, and an emergency notification module 188, as in FIG. 1.

The telephone call module 172 connects a telephone call to the caller terminal 110 based on call access of the caller terminal 110. In the present invention, a screen corresponding to each situation such as an incoming call, call reception, and a call end based on the telephone call module 172 is displayed on the display of the smartphone 100. A “call waiting screen” described hereinafter is a screen output when the telephone call module 172 waits for a response from a user in response to a call access request from the caller terminal 110. A “busy screen” is a screen on which a busy state is displayed from the time when a call with the caller terminal 110 is started to the time when the call is ended. A “call end screen” is a screen displayed to a user in the state in which a call with the caller terminal 110 is terminated.

The silence switching module 174 is a means for displaying a silence switching selection unit 220 on the call waiting screen and switching an incoming ringtone or vibration into silence when the silence switching selection unit 220 is selected by a user.

The advertising link module 176 detects the call access of the caller terminal 110, and displays an advertising display unit 240 for displaying push type advertising content, received over a wireless communication network, on each of the call waiting screen, the busy screen, and the call end screen. When a user selects an advertising content link item 242 on push type advertising content, an advertising link mobile webpage (e.g., an online selling site, a discount coupon provision site, or a web site that provides advertising video in a streaming form) linked to corresponding advertising is automatically linked. On the call waiting screen and the busy screen, the advertising link module 176 may display push type advertising content so that the content automatically slides and moves at predetermined time intervals. On the call end screen, the advertising link module 176 may display the push type advertising content displayed in the slide form so that the content is manually slid and moved.

The busy app link module 178 displays a plurality of link app execution icons, which may be linked by one click, on each of the call waiting screen, the busy screen, the call end screen. If a user selects one of the link app execution icons on each of a call waiting state, a busy state, and a call end state, the busy app link module 178 invokes and executes a corresponding application, so that various applications can be executed by one input even in a call connection state.

Furthermore, all the busy app link module 178, and the caller matching business card search module 180, the schedule management module 182, the permanent memo module 184, the point management module 186, and the emergency notification module 188, which are linked and executed during a call, may check the termination of the execution of an application, and may return a corresponding screen to the original call waiting screen, busy screen or call end screen.

The caller matching business card search module 180 searches for a business card, input or scanned and stored by a user, based on the telephone number of the caller terminal 110 provided through a CID service, extracts a business card including information matched with the telephone number of the caller terminal 110, and displays the business card on the call waiting screen, the busy screen, or the call end screen.

The schedule management module 182 displays a calendar on a screen when a schedule management application execution icon 340 is selected by a user. When a specific date is selected in a calendar or a schedule addition selection button 440 is selected, the schedule management module 182 receives schedule contents from a user and stores the schedule contents.

The permanent memo module 184 executes a memo application when a permanent memo application execution icon 350 is selected by a user. In this case, the permanent memo module 184 may execute the memo application even when it is detected during a call that a stylus pen (not illustrated) inserted into one side of the smartphone 100 is drawn.

The point management module 186 executes a point management application when a point management application execution icon 380 is selected by a user. The point management application may display, on a screen, accumulated points owned by a user and used points used by the user so that the user can check the accumulated points and used points if the user moves to a selling site linked to advertising content and purchases a product.

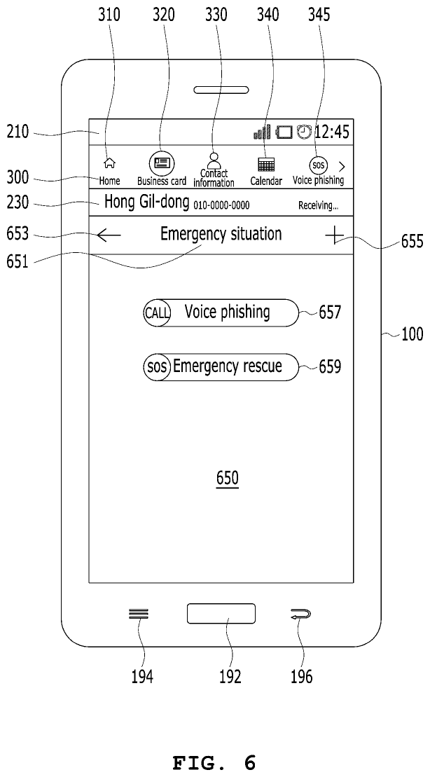

The emergency notification module 188 displays an emergency notification page 650 on the call waiting screen or the busy screen when an emergency notification application execution icon 345 is selected by a user. The emergency notification page 650 provides a user interface for notifying voice phishing or an emergency rescue. A process in which the emergency notification application is executed and a user notifies a designated user of the state in which the user undergoes voice phishing or reports an emergency rescue to the police, a fire station or a cyber safety administration in a call waiting state or during a call will be described later with reference to FIGS. 6 to 9.

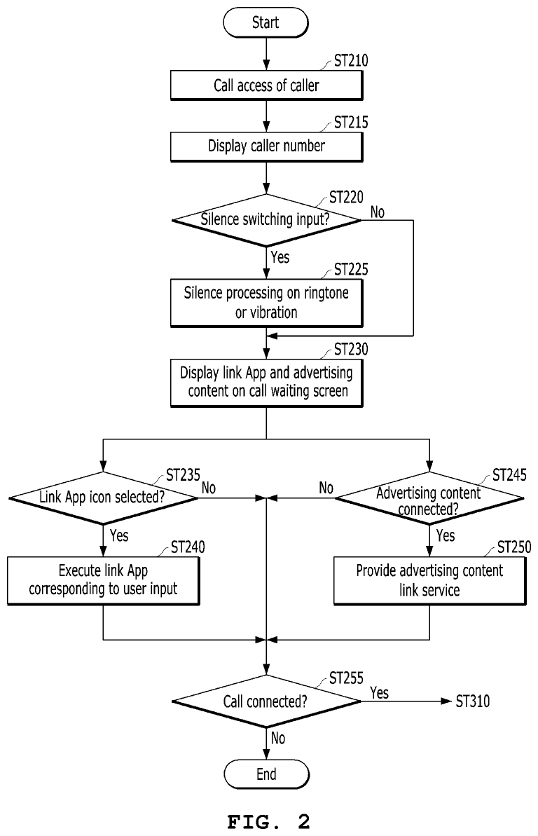

FIGS. 2 to 4 are flowcharts illustrating application link methods in a call waiting screen state, a busy screen state, and a call end screen state, respectively, in the present invention.

Referring to FIG. 2, a step starts from the connection of a telephone call with the caller terminal 110 based on the call access of the caller terminal 110 (ST210). Furthermore, the telephone number of the caller terminal 110 provided by CID service is displayed on a screen of the smartphone 100 (ST215). If the telephone number provided by the CID service is identical with information of contact information stored in the memory 134, the telephone call module 172 may invoke the corresponding information and display the information along with the name of a caller.

In this case, the application link method during a call using a smartphone according to the present invention provides a silence switching mode so that a user is not hindered by an incoming ringtone or vibration when executing a link app in the state in which the user has not exited from the call waiting screen. The silence switching module 174 displays the silence switching selection unit 220 on the call waiting screen. The control unit 150 determines whether the silence switching selection unit 220 has been selected by a user (ST220). If a predetermined input (e.g., a slide input) to the silence switching selection unit 220 is generated, the silence switching module 174 performs silence-processing on an incoming ringtone or vibration (ST225).

Next, an execution icon and advertising content of a link app are displayed on the call waiting screen (ST230).

The busy app link module 178 displays the execution icons (e.g., in a form in which a menu bar is provided on the upper side) of applications that may be linked, on one side of the call waiting screen.

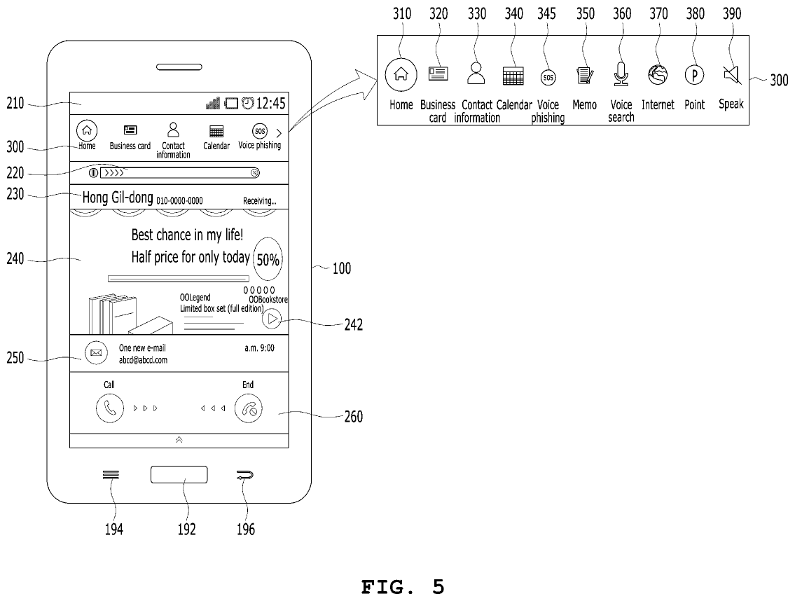

For example, as will be described below with reference to FIGS. 5 to 26, a link application icon display window 300 is displayed on the upper side of the call waiting screen. A main menu move icon, a business card search icon 320, a contact information application execution icon 330, the schedule management application execution icon 340, the emergency notification application execution icon 345, the permanent memo application execution icon 350, a voice search application execution icon 360, an Internet search application execution icon 370, the point management application execution icon 380, and a received sound erasure toggle icon 390 are displayed on the link application icon display window 300.

The advertising link module 176 displays advertising content, provided in a push form, on the advertising display unit 240 located in the middle of the call waiting screen, and provides the advertising content link item 242 for moving to an advertising link mobile webpage 270 within advertising content.

Next, the control unit 150 determines whether any one of the link app icons disposed in the link application icon display window 300 is selected (ST235). If any link app icon is selected, the control unit 150 executes the corresponding link app (ST240).

Alternatively, the control unit 150 determines whether the advertising content link item 242 displayed on the advertising display unit 240 is selected (ST245). If the advertising content link item 242 is selected, the control unit 150 provides a link service to an advertising company that provides corresponding advertising content or a mobile webpage for product selling (ST250).

Next, the control unit 150 determines whether a call connection is performed by a user input (ST255).

If the user selects a call rejection item, the process is terminated without any change. In contrast, if the user selects a call connection item, the process proceeds to step ST310.

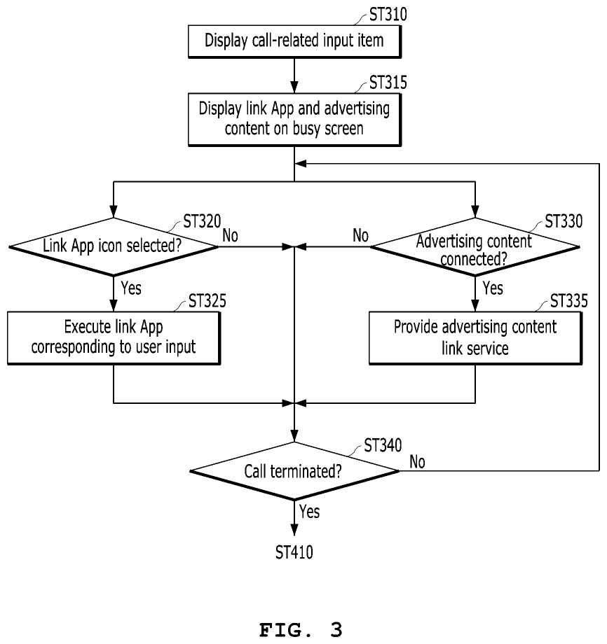

Referring to FIG. 3, at step ST310, a busy state is initiated from the display of a call-related input item. Thereafter, a link app execution icon and advertising content are displayed on the busy screen identically with step ST230 (ST315).

Next, as described above with reference to FIG. 2, whether any one of the link app icons disposed in the link application icon display window 300 is selected is determined (ST320). If any link app icon is selected, the corresponding link app is executed (ST325).

Alternatively, whether the advertising content link item 242 displayed on the advertising display unit 240 is selected is determined (ST330). If the advertising content link item 242 is selected, a link service to an advertising company that provides corresponding advertising content or a mobile webpage for product selling is provided (ST335).

Next, whether a call end is performed by a user input is determined (ST340).

If the user has not selected a call end item, steps after step ST315 continue to be executed. If the user selects the call end item, the process proceeds to step ST410.

The telephone call module 172 of a known smartphone immediately terminates a call connection and returns a screen to a home screen when a user selects a call end item. However, in the present invention, a call end screen is displayed, and an application link mode is executed on the call end screen.

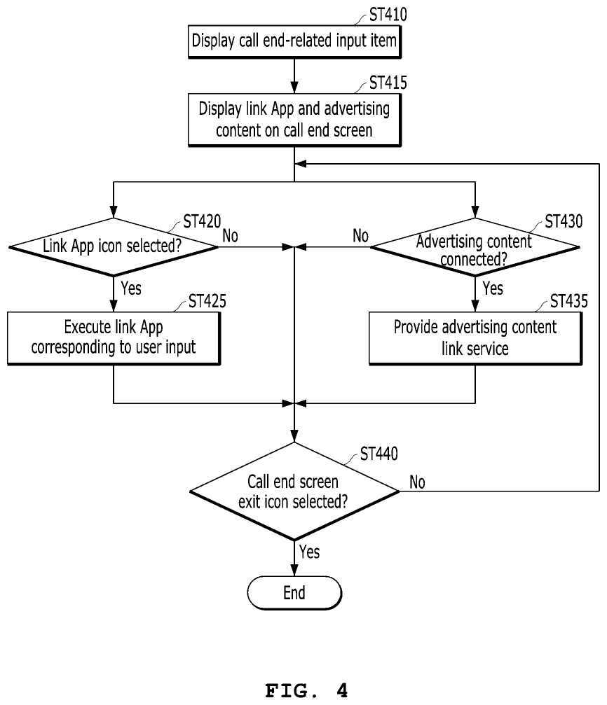

Referring to FIG. 4, a process related to a call end is initiated from the display of a call end-related input item (ST410). The call end-related input item includes at least a call end screen exit icon 292.

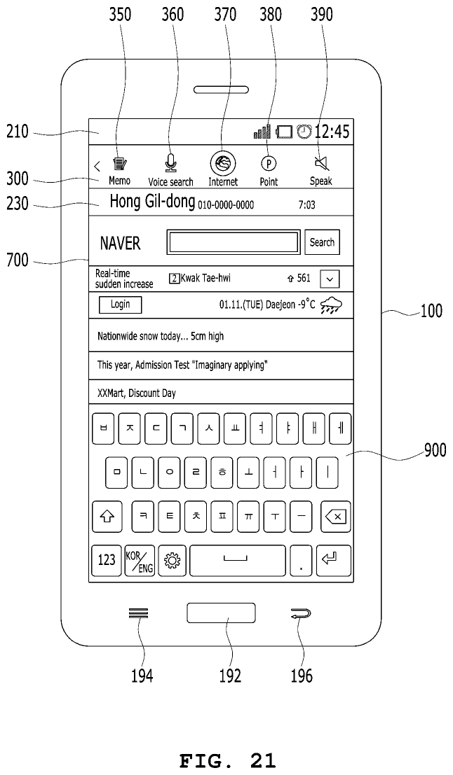

Thereafter, a link app execution icon and advertising content are displayed on the call end screen as described above (ST415). Push type advertising content automatically slides and is displayed on the call waiting screen and the busy screen. In contrast, advertising content displayed in the call waiting and busy states are displayed on the call end screen so that the content can be manually moved and checked. This will be described specifically later with reference to FIG. 21.

Next, as in FIGS. 2 and 3, whether any one of the link app icons disposed in the link application icon display window 300 is selected is determined (ST420). If any link app icon is selected, the corresponding link app is executed (ST425).

Alternatively, whether the advertising content link item 242 displayed on the advertising display unit 240 is selected is determined (ST430). If the advertising content link item 242 is selected, a link service to an advertising company that provides corresponding advertising content or a mobile webpage for product selling is provided (ST435).

Next, whether the call end screen exit icon 292 displayed on the call end screen is selected is determined (ST440). If the user has not selected the call end screen exit icon 292, steps after step ST415 continue to be performed. If the user selects the call end screen exit icon 292, the process is terminated.

An embodiment in which a link app is invoked and executed by one input in each of a call waiting state, a busy state, and a call end state and an embodiment in which an advertising content link service is provided will be described below specifically with reference to FIGS. 5 to 22.

FIG. 5 is a diagram illustrating a call waiting screen when a call is received in the present invention.

Referring to FIG. 5, a state display window 210 in which a battery state, a current time, and received electronic wave sensitivity are displayed is located at the top of the smartphone 100. The link application icon display window 300, the silence switching selection unit 220, a caller number display unit 230, the advertising display unit 240, a push notification window 250, and a call connection/rejection selection unit 260 are disposed below the state display window 210.

The link application icon display window 300 is a window on which the execution icon of a link app capable of immediately executing a link app by one input on the call waiting screen, the busy screen, or the call end screen according to the present invention is displayed. As enlarged and illustrated in FIG. 5, 10 execution icons are displayed on the link application icon display window 300. The 10 execution icons include the main menu move icon 310, the business card search icon 320, the contact information application execution icon 330, the schedule management application execution icon 340, the emergency notification application execution icon 345, the permanent memo application execution icon 350, the voice search application execution icon 360, the Internet search application execution icon 370, the point management application execution icon 380, and the received sound erasure toggle icon 390. Each of the icons is activated by a user's touch input. If a user input to each icon is generated, the busy app link module 178 executes a link app corresponding to the user input.

The main menu move icon 310 is an icon for moving a screen to a main menu from each of the call waiting screen, the busy screen, and the call end screen. In the present invention, the main menu means the state in which any link app is not executed and the advertising display unit 240 is displayed in the middle of a screen, as illustrated in FIG. 5.

The received sound erasure toggle icon 390 is an icon for erasing a voice signal received from a caller. For example, if contact information search or web search is to be performed using voice recognition in each of a call waiting state, a busy state, and a call end state according to the present invention or if an important message is to be solely recorded during a call, a received sound can be prevented from entering a microphone by touching the received sound erasure toggle icon 390 once. When the received sound erasure toggle icon 390 is touched once, the busy app link module 178 erases a received sound in such a way to reduce the volume of a voice signal, received from a caller, to 0 (zero) or block received data. If the received sound erasure toggle icon 380 is touched more again, a received sound returns to its original state.

Examples in which link apps are executed in response to inputs to other link app execution icons will be described later with reference to the following drawings.

The silence switching selection unit 220 is provided in a slide input form, and is configured with an icon through which silence switching can be intuitively recognized and graphics that guide a slide input. If a user slides the silence switching selection unit 220 to the right (or left) using his or her finger or a touch input tool, the silence switching module 174 switches an incoming ringtone or vibration into silence.

In the example of FIG. 5, the link app display window 300 and the silence switching selection unit 220 have been illustrated as being formed in separate display units. However, the link app display window 300 and the silence switching selection unit 220 may be configured so that if the silence switching selection unit 200 is slid, it disappears and the link app display window 300 appears at the place. Such an embodiment can make the display space of the smartphone 100 efficiently used.

The caller number display unit 230 is a portion where the telephone number of a caller provided by the CID service is displayed. If the telephone number of the caller terminal 110 is present in previously stored contact information, as illustrated in FIG. 5, a name stored in the contact information and the telephone number of a caller are displayed together. A message that notifies the waiting of the reception of a call is displayed on a screen on one side of the caller number display unit 230.

The advertising display unit 240 displays advertising content, such as an advertising image or video received from an advertising server, in a blank in which graphics or text related to call reception is not located on the call waiting screen. For example, the advertising display unit 240 is displayed in the middle of the display of the smartphone 100.

If the call access of the caller terminal 110 is detected, the advertising link module 176 is connected to an advertising server, receives push type advertising content provided by the advertising server, converts the frame of the received advertising content suitably for the size of the advertising display unit 240, and displays the converted advertising content.

At this time, pieces of advertising content are displayed in such a way to automatically slide and move at predetermined time intervals. Each of the pieces of advertising content includes the advertising content link item 242 for a movement to an advertising company that provides the advertising content, a product selling place, or the mobile webpage of a discount coupon provider. If a user selects the advertising content link item 242, a link service to the advertising link mobile webpage 270 is provided.

Although not illustrated, the advertising display unit 240 may be configured to display an advertising display stop selection item for stopping advertising display on a screen and to stop advertising display if a user selects the advertising display stop selection item.

The push notification window 250 is the space in which an unconfirmed message, e-mail, a missed call, and notification messages of various applications are displayed.

The call connection/rejection selection unit 260 provides a touch user interface item that connects or rejects a call by a slice input.

Furthermore, as illustrated in the drawing, a home key 192, a menu key 194, and a back key 196 may be provided in a touch key form in a bezel on the lower side of the smartphone 100. As commonly known, the home key 192 is a key for exiting from the call waiting screen and the busy screen and moving to a home screen designated in the smartphone 100. The menu key 194 is a key for activating a menu in a pop-up window form. The back key 196 is a key for moving to a previous screen. The home key 192, the menu key 194, and the back key 196 may also be provided in a soft key form, included in a valid display area, not a physical touch key form.

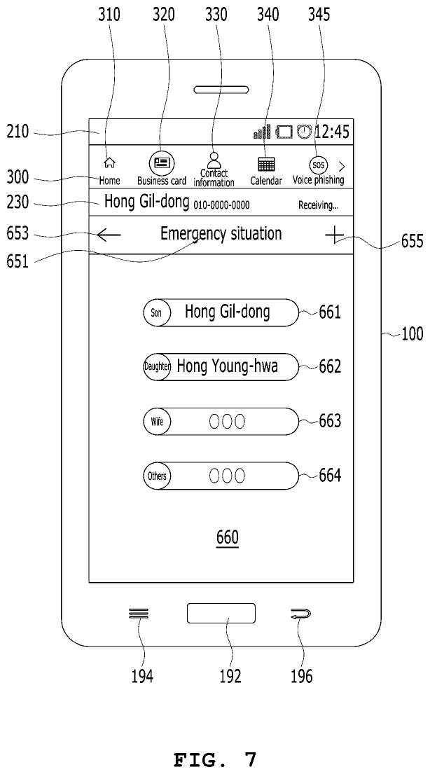

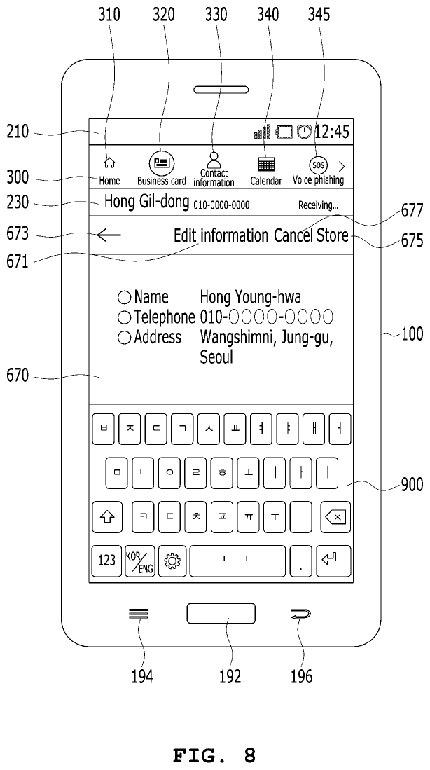

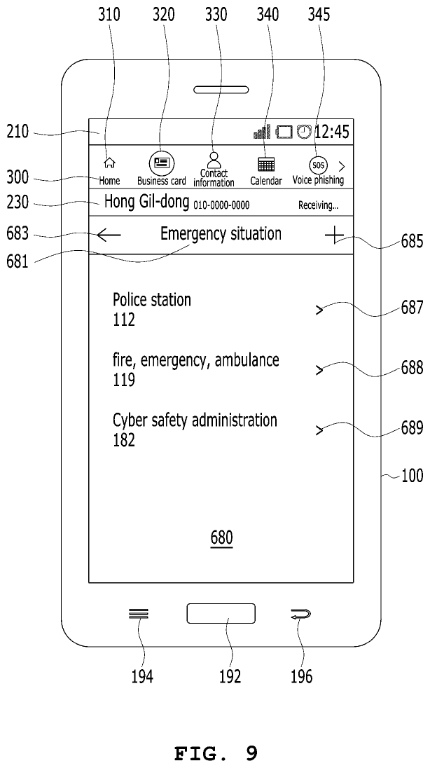

FIGS. 6 to 9 are diagrams illustrating a process of executing an emergency notification application and notifying the outside of voice phishing or an emergency rescue in the present invention. FIG. 6 is a diagram illustrating the state in which an emergency notification application has been executed in the present invention. FIG. 7 is a diagram illustrating the state in which the screen in FIG. 6 has switched to a voice phishing notification screen. FIG. 8 is a diagram illustrating an example in which information of a voice phishing notification subject is edited. FIG. 9 is a diagram illustrating the state in which the screen in FIG. 6 has switched to an emergency rescue notification screen.

The examples of FIGS. 6 to 9 illustrate the state in which an emergency rescue notification application has been executed in the call waiting screen, but the examples may also be identically applied to the busy screen or the call end screen.

If a user selects the emergency notification application execution icon 345 of the link app execution icons, listed in FIG. 5, in the call waiting screen state, as illustrated in FIG. 6, an emergency notification page 650 is displayed on the smartphone 100. The emergency notification page 650 is a page for enabling a user to notify a designated subject of voice phishing or to transmit an emergency rescue signal to a designated subject.

Referring to FIG. 6, an emergency notification display unit 651 having a bar form is positioned at the top of the emergency notification page 650. A back button 653 is positioned at the left end of the emergency notification display unit 651. An addition button 655 is positioned at the right end of the emergency notification display unit 651. If the back button 653 is selected by a user, a screen may return to the call waiting screen illustrated in FIG. 5. If the addition button 653 is selected by a user, a page on which a voice phishing notification subject is newly designated or a page on which an emergency rescue report place is newly designated is activated. Accordingly, a screen switches to a screen on which information on a notification or report subject is edited or input.

A voice phishing notification selection item 657 and an emergency rescue notification selection item 659 are disposed in the middle of the emergency notification page 650. If a user selects the voice phishing notification selection item 657, the emergency notification page 650 switches to a voice phishing notification page 660 illustrated in FIG. 7. If a user selects the emergency rescue notification selection item 659, the emergency notification page 650 switches to an emergency rescue notification page 680 illustrated in FIG. 9.

Referring to FIG. 7, the voice phishing notification page 660 has a structure in which a plurality of notification subject selection items 661, 662, 663, and 664 are listed. Each of the notification subject selection items may display a relation between a user and a notification subject and the name of the notification subject in text form. For example, a first notification subject selection item 661 and a second notification subject selection item 662 may indicate a child relation and the name of the child. A third notification subject selection item 663 may indicate a wife. A fourth notification subject selection item 664 may indicate a person having a different relation.

If a user selects any one notification subject selection item, the emergency notification module 188 may send a text message to the mobile phone of a pre-designated subject. The text message may indicate information indicating that a user is receiving a call suspected as voice phishing. For another example, the emergency notification module 188 may release a call waiting state and attempt a call connection with the mobile phone of a pre-designated subject.

For example, a case where a user receives a voice phishing call of the content that a son is taken as a hostage and then receives a call again from the same caller number or a case where a user recognizes such a voice phishing fact during a call with a caller is assumed. The user may execute the emergency notification application as illustrated in FIG. 6 without exiting from the call waiting screen or the busy screen. Furthermore, the user may select the first notification subject selection item 661 on the voice phishing notification page 660 illustrated in FIG. 7. At this time, if the user is in the call waiting state, the emergency notification module 188 may stop the incoming call and immediately attempt a call connection with the stored mobile phone of the son. For another example, the user may send a text message, reading “A call suspected as voice phishing is being received. Immediately send me a text message capable of checking that you are safe”, to the mobile phone of the son. For still another example, a cyber safety administration may be previously input to the fourth notification subject selection item 664, and such voice phishing may be directly reported to the cyber safety administration.

FIG. 8 is a diagram illustrating an example in which information on a voice phishing notification subject is edited. If a user selects the addition button 655 of FIG. 6, a voice phishing notification subject information edit window 670, such as FIG. 8, is activated. An information edit display unit 671 of a bar form in which an information edit state may be confirmed is positioned at the top of the voice phishing notification subject information edit window 670. A back button 673 is positioned at the left end of the information edit display unit 671. A storage button 675 for storing edited contents and a cancellation button 677 for cancelling edited contents are positioned at the right end of the information edit display unit 671. When a user performs a touch input to the voice phishing notification subject information edit window 670, a virtual keypad 900 may be activated on the lower side of a screen so that the user can enter text. The user may input personal information (e.g., name, telephone number or address) on a voice phishing notification subject through the virtual keypad 900. When the storage button 675 is selected, the input information is matched with the name of the subject and stored.

FIG. 9 is a diagram illustrating the emergency rescue notification page 680. When the emergency rescue notification selection item 659 is selected on the emergency notification page 650 of FIG. 6, a screen of the smartphone 100 switches to the emergency rescue notification page 680 of FIG. 9.

Referring to FIG. 9, an emergency rescue notification display unit 681 of a bar form in which an emergency rescue notification state may be checked is positioned at the top of the emergency rescue notification page 680. A back button 683 is positioned at the left end of the emergency rescue notification display unit 681. An addition button 685 for adding an emergency rescue report subject is positioned at the right end of the emergency rescue notification display unit 681. A crime report connection item 687, a rescue report connection item 688, and a cyber crime report connection item 689 are disposed in the middle of the emergency rescue notification page 680. Such report connection items may be added by a user.

If a user selects the crime report connection item 687, the emergency notification module 188 immediately attempts a call connection with 112 or transmits a message related to a crime report to a server of the National Police Agency. If the user has selected the rescue report connection item 688, the emergency notification module 188 attempts a call connection with 119 or transmits a message related to a rescue report to a firefighting administration server. If the user has selected the cyber crime report connection item 689, the emergency notification module 188 attempts a call connection with 182 or transmits a message related to a cyber crime report to a cyber safety administration server.

For example, if a user is sexually harassed during a call with a caller, the user may select the emergency notification application execution icon 345 on the link application icon display window 300 on the upper side of the busy screen without exiting from the busy screen. Next, the user selects the emergency rescue notification selection item 659 on the emergency notification page 650 illustrated in FIG. 6. Furthermore, when the user selects the crime report connection item 687 on the emergency rescue notification page 680 of FIG. 9, a call connection with 112 is attempted and a crime report history may be left. At this time, although not illustrated, after the crime report connection item 687 is selected, a window in which a text message item to be transmitted to a server of the National Police Agency is selected may be activated. A user may enter text for a crime fact so that the text is transmitted to a server of the

National Police Agency. For another example, after the crime report connection item 687 is selected, call contents with a caller may be automatically recorded. After the call is terminated, a recorded file may be transmitted to a server of the National Police Agency along with report information.

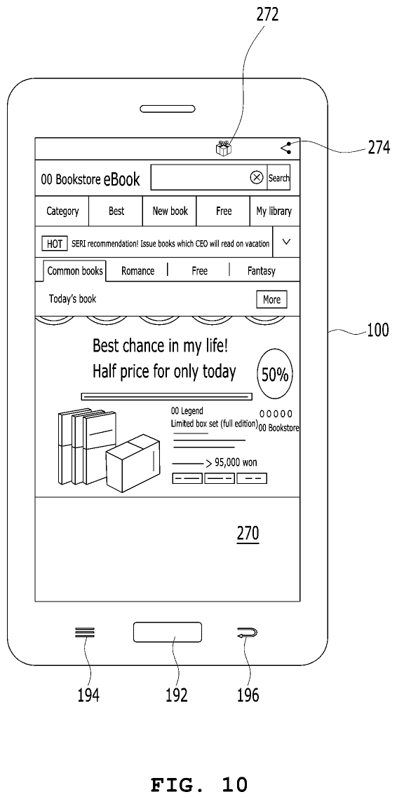

FIG. 10 is a diagram illustrating the state in which the advertising content link item 242 has been selected in the screen of FIG. 5 and the screen has moved to the advertising link mobile webpage.

If a user wants to read more detailed information on desired advertising content in the state of FIG. 5 or if a user wants to purchase a product included in advertising content, the user may want to immediately move to a webpage related to the advertising content. At this time, the user may select the advertising content link item 242.

If the advertising content link item 242 is selected, the advertising link module 176 provides a link service to the advertising link mobile webpage 270 linked to corresponding advertising content. A user may read desired information (e.g., such as a discount coupon provided at the cost of advertising reading), may download a discount coupon, or may purchase a sales promotion product on the advertising link mobile webpage 270.

A gifting icon 272 and a sharing icon 274 may be displayed at the top of the screen of FIG. 10. A user may transmit a downloaded coupon or purchased product (e.g., such as Gifticon) to a stored contact information or SNS account by selecting the gifting icon 272. Furthermore, the user may transmit information on a link to the corresponding advertising link mobile webpage 270 to a stored contact information or SNS account by selecting the sharing icon 274.

The advertising link mobile webpage illustrated in FIG. 10 is a screen identically applied to a case where the advertising content link item 242 is selected on the busy screen or the call end screen.

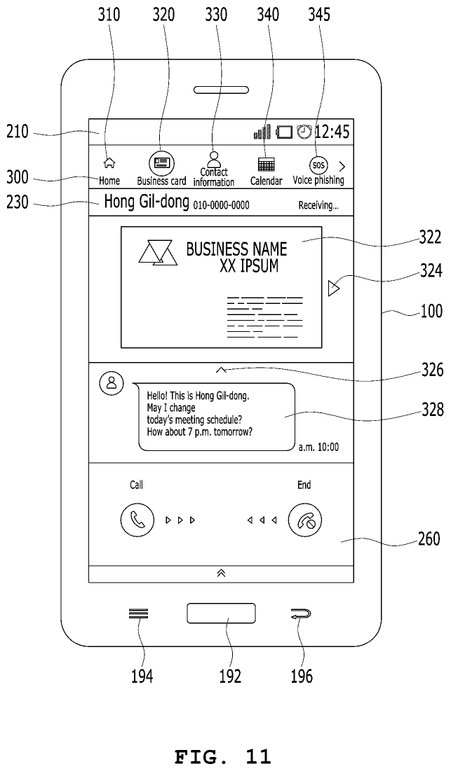

FIG. 11 is a diagram illustrating the state in which the business card search icon 320 is selected and a business card search application is executed on the call waiting screen.

Referring to FIG. 11, the business card search icon 320 is activated on the link application icon display window 300. The caller matching name business card search module 180 searches for a business card matched with the telephone number of a caller, and displays the searched number on a business card display unit 322. Accordingly, a user may obtain detailed information on the caller prior to a call connection with the caller.

A next business card move item 324 is displayed on the right of the business card display unit 322. If the user selects the next business card move item 324, an image of the next business card or the back of the business card of the caller is displayed.

A text message display window 328 is displayed below the business card display unit 322. The text message display window 328 displays text messages exchanged with the caller. A text message display window unfolding item 326 is displayed above the text message display window 328. If the user selects the text message display window unfolding item 326, the text message display window 328 is unfolded and displayed up to the display area of the business card display unit 322.

The caller matching business card search module 180 may additionally provide a function for searching for a business card of a third party. Although not illustrated, the caller matching business card search module 180 may provide a business card search window in which a business card of a third party may be searched for. If a user inputs a name, a telephone number, a company name, or information for other personal identification to the business card search window, the caller matching business card search module 180 may extract a business card, matched with the input information, from the memory 134 embedded in the smartphone 100 or a web database server (not illustrated), and may display the business card through the business card display unit 322. In this case, the business card extracted from the web database server may be understood as including information on a third party (e.g., a name, a telephone number, a company name, or other personal identification information), stored in a business card form by the user or caller, in addition to a scanned image of a business card having a printed form. The business card of the third party may be stored on the smartphone 100 by substituting the business card of the caller. For another example, the business card of a caller and the business card of a third party may be divided and displayed on a single screen.

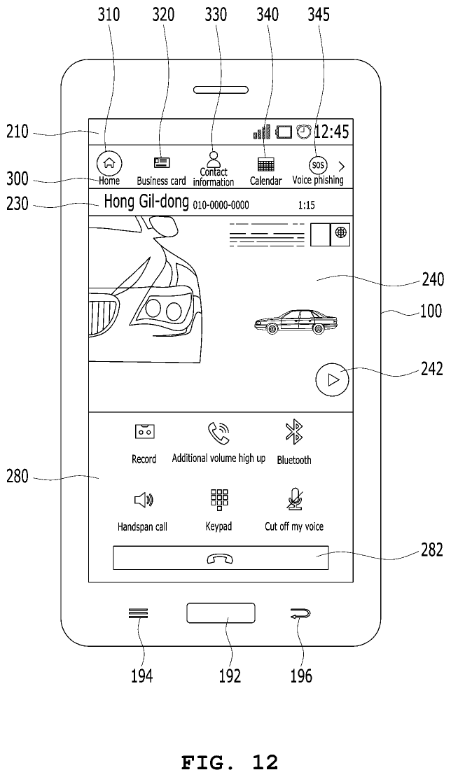

FIG. 12 is a diagram illustrating the main menu state of the busy screen, and illustrates the state in which a call with a caller is initiated and the main menu move icon 310 is activated.

If a user connects to a call by selecting the call connection/rejection selection unit 260 on the call waiting screen, the call waiting screen switches to a busy screen, as in FIG. 12.

Referring to FIG. 12, in the main menu state of the busy screen, the advertising display unit 240 is displayed in the middle of the busy screen and a calling menu display window 280 is displayed on the lower side of the busy screen.

If the user selects the advertising content link item 242 on the advertising display unit 240, the busy screen moves to the advertising link mobile webpage 270 as described above with reference to FIG. 10.

The calling menu display window 280 displays a recording icon, an additional volume increase up icon, a Bluetooth icon, a handspan call icon, a keypad icon, and a sending sound blocking icon, as commonly known. In addition, a call end input item 282 selected if a call is to be ended is displayed on the calling menu display window 280.

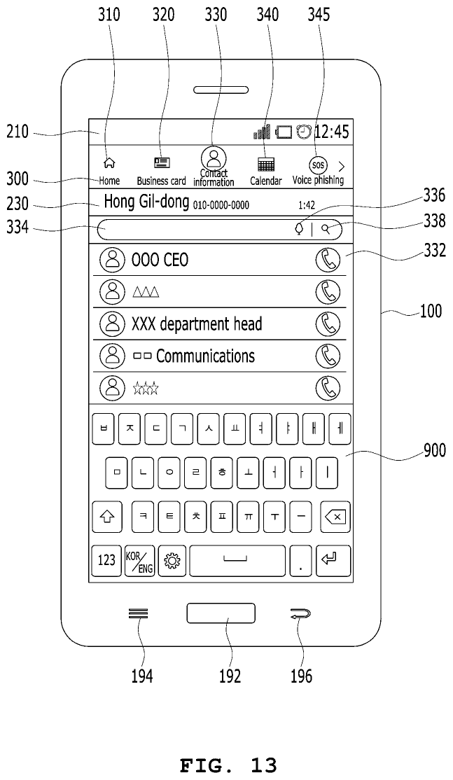

FIG. 13 is a diagram illustrating the state in which a contact information application has been executed in a busy state, and illustrates the state in which if a user selects the contact information application execution icon 330 on the link application icon display window 300, the busy app link module 178 invoked and executed the contact information application basically installed in the smartphone 100.

Referring to FIG. 13, the contact information application execution icon 330 is activated on the link app display window 300. A contact information display window 332 is displayed in the middle of the screen.

A contact information search window 334 in which contact information may be searched for by entering the contact information is displayed above the contact information display window 332. As illustrated, if a cursor is placed in the contact information search window 334, the virtual keypad 900 appears at the bottom of the screen so that contact information can be searched for using the virtual keypad 900.

A contact information search selection button 338 for searching for input contact information is displayed at the right end of the contact information search window 334. A voice search selection button 336 for searching for contact information through a user's voice input is displayed adjacent to the contact information search selection button 338.

If a user wants to search for contact information through a voice input, the user may cut off the received sound of a caller by selecting the received sound erasure toggle icon 390 described with reference to FIG. 5, and may perform voice search by selecting the voice search selection button 336. After the voice search is completed, the user may restore the received sound normally by selecting the received sound erasure toggle icon 390 once more.

As illustrated in FIG. 13, a user can execute a contact information application by one input without exiting from a busy screen. Accordingly, it is possible to very easily implement to confirm contact information of a third party or notify a caller of contact information of a third party during a call.

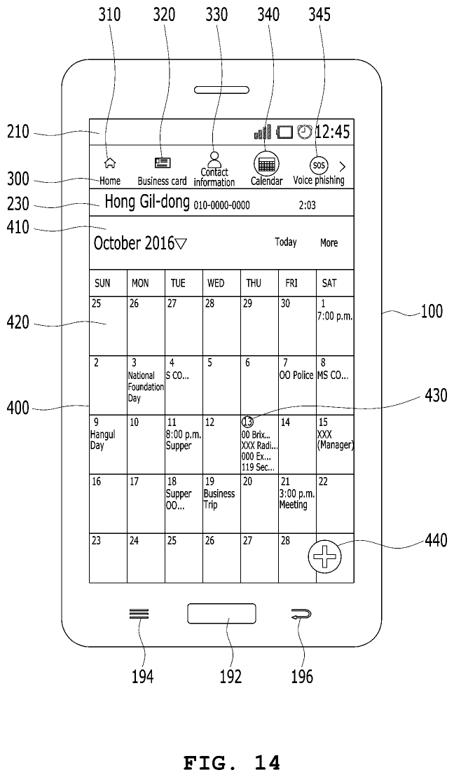

FIGS. 14 to 17 are diagrams illustrating the state in which schedule management application is executed during a call.

A user may need to confirm or newly write an important schedule with a caller during a call. In this case, conventionally, a user has to exit from a busy screen and execute a schedule management application. In contrast, in the present invention, a user can confirm and write a schedule by immediately executing a schedule management application on a busy screen.

Referring to FIG. 14, if a user selects the schedule management application execution icon 340 on the link application icon display window 300, the corresponding icon is activated and a calendar display unit 400 of FIG. 14 is displayed.

A year and month display unit 410 is positioned at the top of the calendar display unit 400. A date display unit 420 in which the dates of a month is positioned in the middle of the calendar display unit 400. A today's date indication mark 430 is displayed at a location corresponding to a today's date in the date display unit 420. A schedule addition selection button 440 for newly adding a schedule is provided at the right bottom of the calendar display unit 400.

A user may input a desired schedule by selecting the date display unit 420, to which a schedule will be added, with tapping or by selecting the schedule addition selection button 440 with tapping. Furthermore, a user may confirm a schedule by selecting the date display unit 420 corresponding to a desired date. If a user inputs a new schedule, the schedule management module 182 stores schedule information, input by the user, in the memory 134.

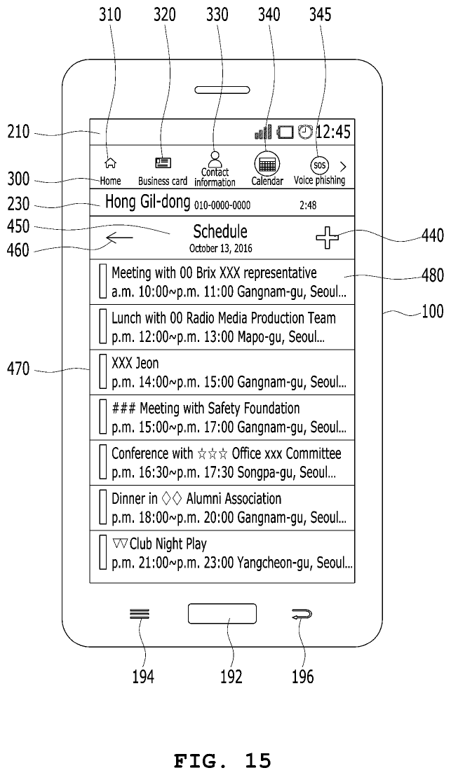

FIG. 15 is a diagram illustrating the state in which the schedule of a specific date is displayed in the state of FIG. 14.

Referring to FIG. 15, if a user wants to confirm a today's schedule by selecting October 13 in the date display unit 420, a today's date and a schedule-related title are displayed on a schedule indication state bar 450. A back button 460 for returning to the calendar display unit 400 of FIG. 14 is displayed on the left of the schedule display state bar 450. The schedule addition selection button 440 for adding a schedule to a corresponding date is displayed on the right of the schedule display state bar 450.

A schedule display window 470 in which the schedules of a corresponding date are displayed in time series is displayed below the schedule display state bar 450. Text indicative of each of the schedules in the schedule display window 470 is individually partitioned to form an individual schedule selection item 480.

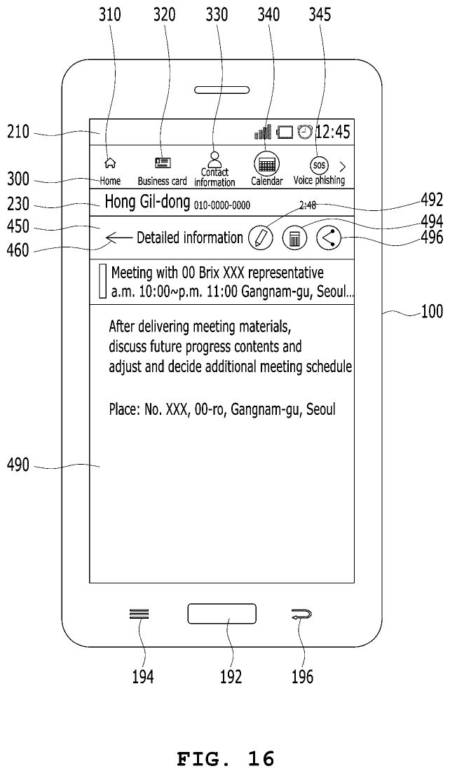

If a user selects the desired individual schedule selection item 480 in order to confirm an individual schedule, as in FIG. 16, the state of FIG. 15 switches to the state in which detailed contents of a specific schedule are displayed.

Referring to FIG. 16, a back button 460 for returning to the schedule display window 470 is displayed on the left of the schedule display state bar 450. A schedule edit item 492 for editing a corresponding individual schedule, a schedule deletion item 494 for deleting a corresponding individual schedule, and a schedule sharing item 496 for sharing a corresponding individual schedule are displayed on the right of the schedule display state bar 450.

A detailed schedule display window 490 for displaying detailed contents of a corresponding individual schedule is displayed below the schedule display state bar 450.

A user may edit detailed contents of an individual schedule by selecting the schedule edit item 492. At this time, a cursor may be activated in the detailed schedule display window 490, and then the virtual keypad 900 may pop up and appear from the bottom of the screen.

If a user wants to share an individual schedule with a caller or a third party, the user may share the individual schedule by selecting the schedule sharing item 496.

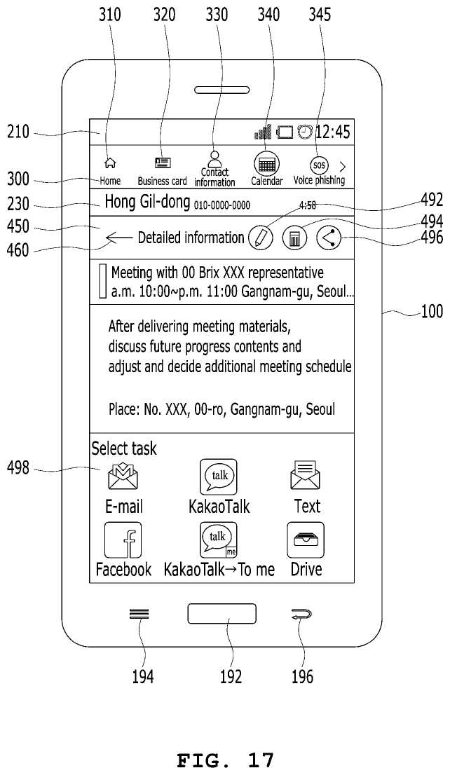

FIG. 17 is a diagram illustrating the state in which a sharing type of a specific schedule is selected in the state of FIG. 16.

Referring to FIG. 17, if a user selects the schedule sharing item 496, a schedule sharing means selection window 498 pops up and appears from the bottom of the screen illustrated in FIG. 16. The schedule sharing means selection window 498 includes icons for selecting means capable of sharing a schedule, such as e-mail, a text message, a web hard, and an SNS. The user may share a specific schedule by selecting a desired sharing means.

For example, if the user selects the text message in the screen of FIG. 17, information displayed on the detailed schedule display window 490 is transmitted to a caller or contact information of a third party in an SMS or MMS message form.

As described above, there is an advantage in that a schedule can be mutually confirmed in a cross-check way because specific schedule information is transmitted to and confirmed by a caller or a third party in a busy state.

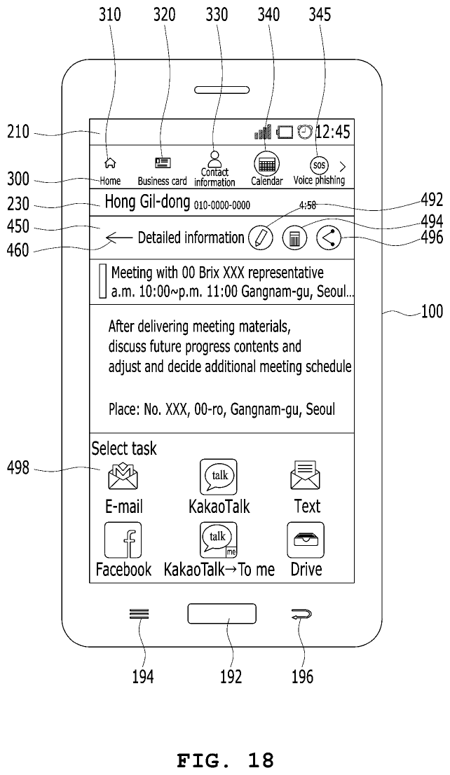

FIG. 18 is a diagram illustrating the state in which the permanent memo application is executed during a call, and illustrates the state in which a user has selected the permanent memo application execution icon 350 on the link application icon display window 300.

Referring to FIG. 18, a memo management state bar 510 is displayed below the caller number display unit 230. A memo addition selection button 520 for newly adding a memory is displayed on the right of the memo management state bar 510. A memo display window 530 on which the titles of stored memos are displayed in time series is displayed below the memo management state bar 510.

Text indicative of the title of an individual memo on the memo display window 530 is partitioned to form an individual memo selection item 540.

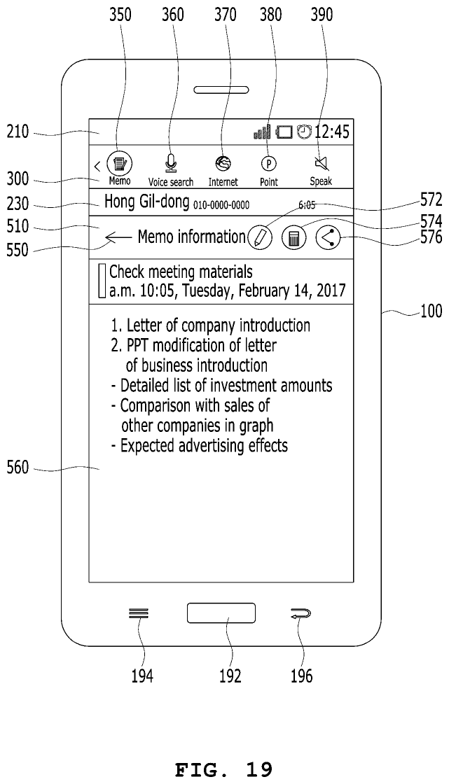

If a user selects a desired individual memo selection item 540 in order to confirm an individual memo, the state of FIG. 18 switches to the state in which detailed contents of a specific memo are displayed as in FIG. 19.

Referring to FIG. 19, a back button 550 for returning to the memo display window 530 is displayed on the left of the memo management state bar 510. A memo edit item 572 for editing a corresponding memo, a memo deletion item 574 for deleting a corresponding memo, and a memo sharing item 576 for sharing a corresponding memo are displayed on the right of the memo management state bar 510.

A detailed memo display window 560 indicative of detailed contents of a corresponding memo is displayed below the memo management state bar 510.

A user may edit detailed contents of an individual memo by selecting the memo edit item 572. At this time, a cursor is activated in the detailed memo display window 560, and then the virtual keypad 900 may pop up and appear from the bottom of the screen. Alternatively, the user may write a new memo in the detailed memo display window 560 using a stylus pen. The permanent memo module 184 stores the memo input by the user.

A user may share a stored memo with a caller or a third party by selecting the memo sharing item 576. If a user selects the memo sharing item 576, the icons for selecting means capable of sharing a memo, such as e-mail, a text message, a web hard, and an SNS, are activated as described above with reference to FIG. 17. The user may share a specific memo by selecting a desired sharing means.

Although not illustrated, the permanent memo module 184 may detect that the stylus pen inserted into one side of the smartphone 100 is drawn, and may execute the permanent memo application as in FIG. 18 if the stylus pen is drawn.

As described above, according to the present invention, a memo application can be immediately executed by only an operation of selecting the permanent memo application execution icon 350 or drawing the stylus pen even in the busy state. Accordingly, there is an advantage in that a task for noting important call contents or sharing a stored memo can be immediately performed by one click on a busy screen.

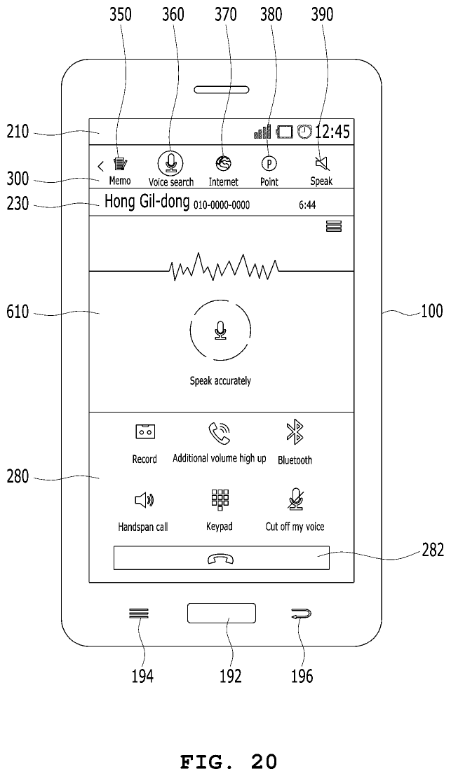

FIG. 20 is a diagram illustrating the state in which a voice search application is executed during a call.

Referring to FIG. 20, a user may perform voice search by selecting the voice search application execution icon 360 on the link application icon display window 300.

The busy app link module 178 invokes and executes a voice search engine in accordance with the selection of the voice search application execution icon 360. A voice search state display window 610 is displayed on a screen of the smartphone 100. In order to prevent a received sound from being mixed during voice search, the received sound erasure toggle icon 390 may be used as described above.

As described above, a user may invoke and execute the voice search engine by one click without exiting from a busy screen. The user can search for stored information or information on a web through voice search.

FIG. 21 is a diagram illustrating the state in which an Internet search application is executed during a call.

Referring to FIG. 21, a user may perform Internet search by selecting the Internet search application execution icon 370 on the link application icon display window 300.

The busy app link module 178 invokes and executes an Internet search application in accordance with the selection of the Internet search application execution icon 370. An Internet homepage display window 700 is displayed on a screen of the smartphone 100. An access screen of a preset Internet homepage is displayed on the Internet homepage display window 700. A user can perform Internet search by one click without exiting from a busy screen.

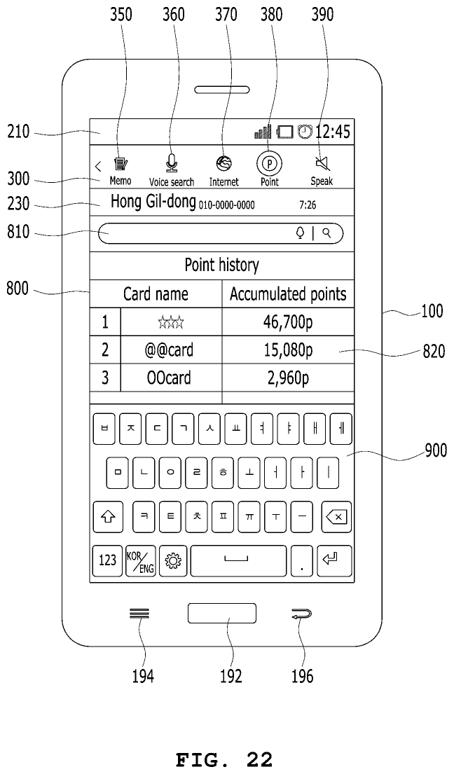

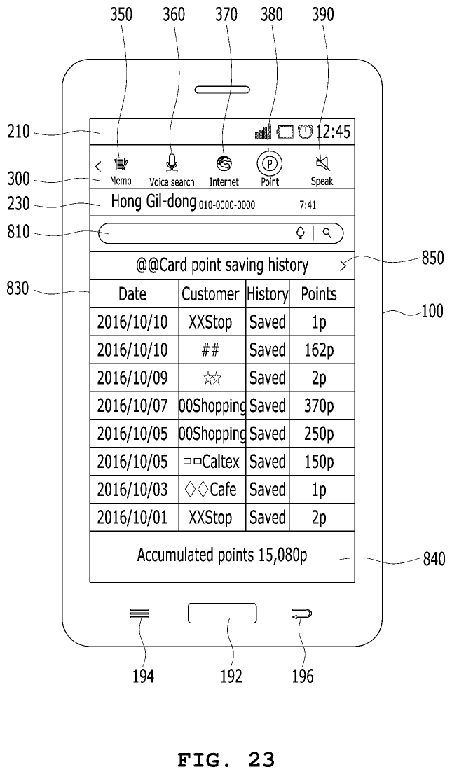

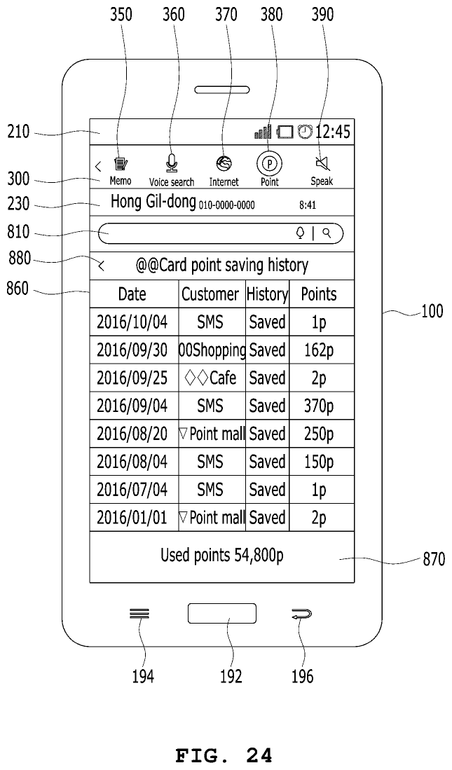

FIG. 22 is a diagram illustrating the state in which a point management application is executed during a call. FIGS. 23 and 24 are diagrams illustrating the state in which a point saving history and a point use history have been displayed.

Referring to FIG. 22, a user may check accumulated points and used points by selecting the point management application execution icon 380 on the link application icon display window 300.

The point management module 186 displays a point history display window 800 on a screen in accordance with the selection of the point management application execution icon 380, as illustrated in FIG. 22. A target for which points are to be saved, such as a credit card or a check card, and the accumulated points of each target for which the points are to be saved are displayed on the point history display window 800.

A point search window 810 for searching for points is displayed at the top of the point history display window 800. If a user selects the point search window 810, the virtual keypad 900 pops up and is displayed from the bottom of the screen. The user may search for a target for which the points are to be saved by inputting the target through the virtual keypad 900, or may search for a target, for which the points are to be saved, through a voice input by selecting a voice search icon formed on the point search window 810.

The point history display window 800 is provided in a table form as illustrated. Each of pieces of text forms an individual point selection item 820. If a user selects the individual point selection item 820, the state of FIG. 22 proceeds to the state of FIG. 23 in which the point saving history of a corresponding card is displayed.

Referring to FIG. 23, a point saving history display window 830 in which a point saving history is displayed for each date is displayed in the middle of the screen. An accumulated point display unit 840 indicative of a total of accumulated points of the corresponding card is displayed below the point saving history display window 830.

A sentence indicative of the name and point saving history of the target card is displayed at the top of the point saving history display window 830. A use history move item 850 for moving to a point use history display state is displayed on the right thereof. If a user selects the use history move item 850, the state of FIG. 23 proceeds to the state of FIG. 24 in which the point use history of the corresponding card is displayed.

Referring to FIG. 24, a point use history display window 860 in which a point use history is displayed for each date is displayed in the middle of the screen. A used point display unit 870 indicative of a total of used points of the corresponding card is displayed at the bottom of the point use history display window 860.

A sentence indicative of the name and point use history of the target card is displayed at the top of the point use history display window 860. An accumulation history move item 880 for moving to the point saving history indication state is displayed on the left thereof. If a user selects the accumulation history move item 880, the state of FIG. 24 proceeds to the state of FIG. 23 in which the point saving history of the corresponding card is displayed.

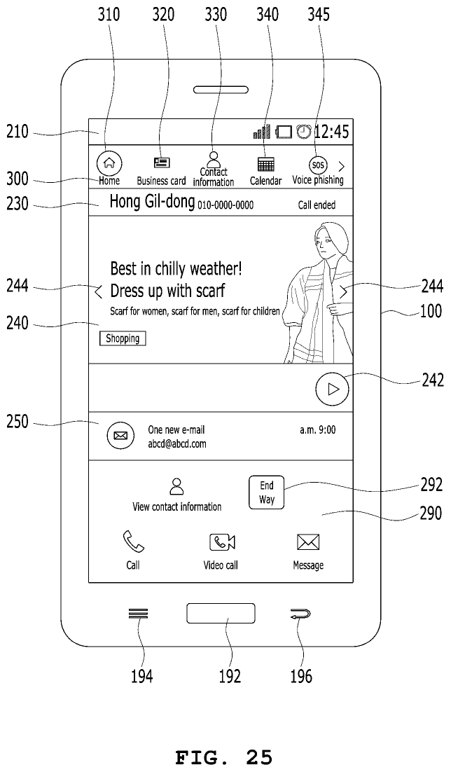

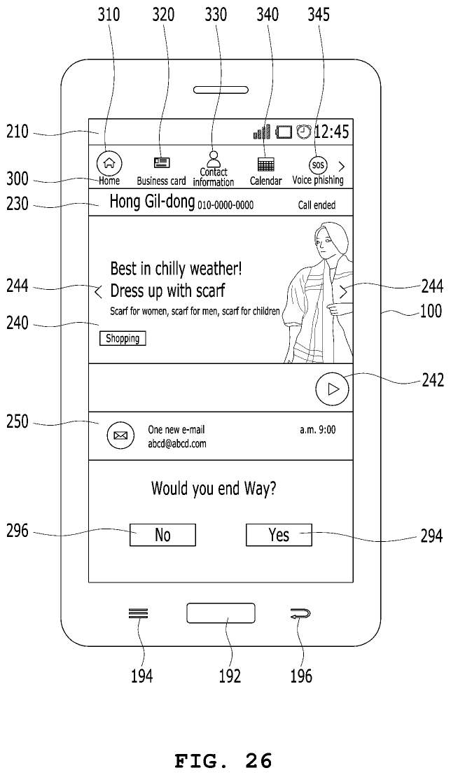

FIG. 25 is a diagram illustrating the state in which a call end screen is executed. FIG. 26 is a diagram illustrating the state which a call end screen exit is selected in the state of FIG. 25.

If a user selects a call end button, the telephone call module 172 of a conventional smartphone 100 immediately terminates a call connection. In contrast, in the present invention, a call end screen is displayed to enable the provision of advertising content and the execution of a link app on the call end screen. Accordingly, a user can reconfirm advertising content in which the user has been interested in a call waiting state and a busy state, and can perform schedule management or memo writing related to a call. In the present invention, a call end screen means a screen on which although a call connection with a caller is terminated, the display of push type advertising content and the utilization of a link app are still available.

Referring to FIG. 25, the advertising display unit 240, such as FIGS. 5 and 12, is displayed on a call end screen. A difference from the examples of FIGS. 5 and 12 is that advertising content is manually slid, moved and displayed.

The advertising link module 176 detects a call end, displays not only push type advertising content having been displayed on a call waiting screen and a busy screen, but also displays slide selection items 244 at ends on both sides of the advertising display unit 240. If a user selects the slide selection item 244, advertising content is switched and displayed. The user may check all of types of advertising content having been received in a call waiting state and busy state using the slide selection items 244 on the left and right.

If a user selects an advertising content link item 242 on the advertising display unit 240, a link service to the advertising link mobile webpage 270 is provided as described above with reference to FIG. 10.

The push notification window 250 is displayed below the advertising display unit 240. A call end menu display window 290 is displayed below the push notification window 250.

The call end menu display window 290 displays a contact information view for checking contact information of a caller, a call button and video call button for attempting a call again, and a button for transmitting a message. In addition, the call end screen exit icon 292 is displayed.

The call end screen exit icon 292 is an icon for fully exiting from a call end screen provided by the present invention. If a user selects the call end screen exit icon 292, the state of FIG. 25 proceeds to the state of FIG. 26.

Referring to FIG. 26, as the call end menu display window 290 is deactivated, an exit selection item 294 and an exit cancellation item 296 for confirming whether a user has exited from the call end screen appear on the disappeared call end menu display window 290. If the exit cancellation item 296 is selected, the screen of FIG. 26 returns back to the call end screen of FIG. 25. If the exit selection item 294 is selected, the display of the call end screen is immediately stopped, and the provision of the application link method during a call using a smartphone according to the present invention is terminated.

In accordance with the system and method for a link to an application during a call using a smartphone according to the present invention, there are effects in that a user can effectively use applications even during a call and user convenience can be enhanced by providing a link app execution menu capable of executing applications by one click on a call waiting screen, busy screen, or call end screen and enabling a user to execute link apps by one input and return to an original screen related to a call.

Furthermore, according to the present invention, there are effects in that a user can execute an emergency notification application by one click on a call waiting screen or a busy screen and can confirm a voice phishing fact through a pre-designated mobile phone of a child, immediately report a crime scene to the police or report an urgent situation to a fire station for immediate measures, while the user stays on the line with a caller, by notifying pre-designated contact information of the voice phishing fact or transmitting an emergency rescue signal to the police, a fire station or an cyber safety administration on an emergency notification page.

Furthermore, according to the present invention, there is an effect in that various types of promotion information and discount benefits can be provided to a user by providing advertising content and link service to an idle space in an environment in which a link app is not executed.

Furthermore, according to the present invention, a user can easily read detailed information on a caller and text messages exchanged with the caller because a business card matched with caller information and text messages exchanged with the caller are searched for and provided by one click operation of selecting a business card icon on a call waiting screen or a busy screen.

Furthermore, according to the present invention, a user can immediately check and write a schedule, related to a call, in relation to the year, month and day of a calendar because a schedule management application is displayed on a screen of a call connection state.

Furthermore, according to the present invention, there is an effect in that a user can cross-check a schedule or memo in real time by transmitting and sharing a specific schedule or memo during a call to and with a caller or a third party.

Furthermore, according to the present invention, when contact information or Internet search is performed using a voice recognition engine during a call, easy and fast voice search can be performed because a received sound is cut off in a toggle way by one click on a call connection screen using a received sound erasure toggle icon, and user convenience can be improved because a voice signal can be converted into text for an input.

Effects of the present invention are not limited to the above-described effects, and other effects not described above will be evidently understood by those skilled in the art from the following description.

The disclosed invention above may be modified in various ways within a range that does not impair a basic spirit. That is, all the embodiments should be interpreted as being illustrative and are not interpreted as being limitative. Accordingly, the scope of protection of the present invention should be determined by the claims, not the above embodiments. If a limited element in the appended claims is substituted with an equivalent thereof, this should be construed as belonging to the scope of the protection of the present invention.

The present invention may be used for the smartphone field and the OS and application fields installed in smartphones.

What is claimed is:

1. An application link system during a call using a smartphone, comprising:
a telephone call module configured to connect a telephone call with a caller terminal based on call access of the caller terminal and display a call waiting screen for waiting for a response from a user corresponding to the call access, a busy screen for displaying a busy state with the caller terminal, and a call end screen for displaying a termination state of a call with the caller terminal; and
a busy app link module configured to provide a link application icon display window comprising a plurality of link app execution icons on the call waiting screen or the busy screen, invoke a corresponding link app when the link app execution icon is selected and execute the corresponding link app on each of the call waiting screen and the busy screen, and automatically return a screen to the call waiting screen or the busy screen when the use of the link app is terminated.

2. The application link system of claim 1, wherein:
an emergency notification application execution icon is displayed on the link application icon display window, and
the application link system further comprises an emergency notification module configured to display an emergency notification page on which a user interface for notifying voice phishing or an emergency rescue is provided on the call waiting screen or the busy screen if the emergency notification application execution icon is selected by a user and to notify a pre-designated subject of a voice phishing state or transmit an emergency rescue signal to the pre-designated subject in accordance with the user's input.

3. The application link system of claim 2, wherein the emergency notification page comprises:
a voice phishing notification selection item which is a user input item for notifying the designated subject of the voice phishing state, and
an emergency rescue notification selection item which is a user input item for transmitting the emergency rescue signal.

4. The application link system of claim 3, wherein when the voice phishing notification selection item is selected by a user, the emergency notification module activates a voice phishing notification page on which the user designates a voice phishing notification subject and transmits a text message for notifying the voice phishing to a subject selected by the user on the voice phishing notification page or attempts a call connection with a mobile phone of the corresponding subject.

5. The application link system of claim 3, wherein when the emergency rescue notification selection item is selected by a user, the emergency notification module activates an emergency rescue notification page on which the user selects an emergency rescue report subject and transmits an emergency rescue signal to a report place selected by the user on the emergency rescue notification page or attempts a call connection with a telephone number of the report place.

6. The application link system of claim 1, further comprising a silence switching module configured to display a silence switching selection unit for switching a ringtone or vibration indicative of an incoming call on the call waiting screen into silence on a screen and to switch an incoming ringtone or vibration into silence when the silence switching selection unit is selected by a user.

7. The application link system of claim 6, wherein:
the silence switching selection unit is displayed on a screen in a slide input form on top of the call waiting screen, and
when the silence switching selection unit is slid and selected, the silence switching selection unit disappears and the link application icon display window is displayed at a corresponding location on the screen.

8. The application link system of claim 1, further comprising an advertising link module configured to provide advertising content and an advertising content link item on each of the call waiting screen, the busy screen, and the call end screen in a main menu state in which the link app has not been executed and to provide a link service to an advertising link mobile webpage associated with the advertising content when the advertising content link item is selected.

9. The application link system of claim 8, wherein:
the advertising link module displays push type advertising content on the call waiting screen and the busy screen so that the push type advertising content automatically slides and moves at given time intervals, and displays the advertising content, sliding and moving on the call waiting screen and the busy screen, on the call end screen so that the advertising content is manually slid and moved, and
the telephone call module provides a call end screen exit icon on the call end screen after a call end is selected by a user and terminates the call end screen if the call end screen exit icon is selected by a user.

10. The application link system of claim 8, wherein:
a main menu move icon is displayed on the link application icon display window, and
the advertising link module changes a state in which another link app is executed into a state in which the advertising content is displayed when the main menu move icon is selected by a user.

11. The application link system of claim 1, wherein:
a business card search icon is displayed in the link application icon display window, and
the application link system further comprises a caller matching business card search module configured to extract a business card previously stored in a memory in accordance with a caller telephone number provided by a caller identification display service when the business card search icon is selected and to display the business card on a screen.

12. The application link system of claim 11, wherein the caller matching business card search module is adjacent to a business card display unit in which the business card is displayed and displays text messages, exchanged with the caller telephone number, on a screen.

13. The application link system of claim 1, wherein:
a contact information application execution icon is displayed on the link application icon display window, and
the busy app link module invokes and executes a contact information application installed in the smartphone when the contact information application execution icon is selected.

14. The application link system of claim 1, wherein:
a schedule management application execution icon is displayed on the link application icon display window, and
the application link system further comprises a schedule management module configured to display, on a screen, a calendar display unit in which a calendar is displayed, a date display unit in which a date and a schedule title of a corresponding date are displayed, and a schedule addition selection button for adding and writing a new schedule when the schedule management application execution icon is selected by a user.

15. The application link system of claim 14, wherein if any one of the date display units is selected by a user, the schedule management module provides a schedule display window in which schedules of a corresponding date are displayed in time series, provides text, indicative of an individual schedule, as an individual schedule selection item capable of a touch input on the schedule display window, and displays, on a screen, a detailed schedule display window in which a corresponding schedule is displayed in detail when the individual schedule selection item is selected by a user.

16. The application link system of claim 15, wherein:
the schedule management module provides a schedule sharing item on one side of the detailed schedule display window and provides a schedule sharing means selection window in which a sharing means of a corresponding schedule is selected when the schedule sharing item is selected by the user,
at least two schedule sharing means selection items of e-mail, a text message, a web hard, and an SNS are displayed on the schedule sharing means selection window, and
when any one of the schedule sharing means selection items is selected, schedule information written in the detailed schedule display window is transmitted and shared through a selected sharing means.

17. The application link system of claim 1, wherein:
a permanent memo application execution icon is displayed on the link application icon display window, and
the application link system further comprises a permanent memo module configured to invoke and execute a memo application when the permanent memo application execution icon is selected by a user.

18. The application link system of claim 17, wherein the permanent memo module invokes and executes the memo application when a drawing of a stylus pen inserted into one side of the smartphone is detected if any one of the call waiting screen, the busy screen, and the call end screen is displayed by the telephone call module.

19. The application link system of claim 1, wherein:
a voice search application execution icon is displayed in the link application icon display window, and
the busy app link module invokes and executes a voice search engine installed in the smartphone when the voice search application execution icon is selected by a user.

20. The application link system of claim 1, wherein:
an Internet search application execution icon is displayed in the link application icon display window, and
the busy app link module invokes and executes an Internet search application installed in the smartphone when the Internet search application execution icon is selected by a user.

21. The application link system of claim 1, wherein:
a point management application execution icon is displayed on the link application icon display window, and
the application link system further comprises a point management module configured to display accumulated points and used points of a user on a screen when the point management application execution icon is selected by the user.

22. The application link system of claim 1, wherein:
a received sound erasure toggle icon is displayed on the link application icon display window, and
the busy app link module changes an erasure or return of a received sound when the received sound erasure toggle icon is selected by a user.

23. An application link method during a call using a smartphone, comprising:
(a) providing a call waiting screen for waiting for a response from a user in accordance with call access of a caller terminal;
(b) providing a busy screen for displaying a call connection state with the caller terminal when a call connection is selected by a user on the call waiting screen; and
(c) providing a call end screen for displaying a termination state of a call with the caller terminal when a call end is selected by a user on the busy screen,
wherein a link application icon display window comprising a plurality of link app execution icons is provided on each of the call waiting screen or the busy screen,
when the link app execution icon is selected, a corresponding link app is invoked and executed on each of the call waiting screen and the busy screen, and
when the execution of the link app is terminated, a screen automatically returns to the call waiting screen or the busy screen.

24. The application link method of claim 23, wherein:
advertising content and an advertising content link item are provided on each of the call waiting screen, the busy screen, and the call end screen, and
when the advertising content link item is selected, a link service to an advertising link mobile webpage associated with the advertising content is provided.
